(19) United States
(12) Patent Application Publication
(10) Pub. No.: US 2023/0274634 A1
(43) Pub. Date: Aug. 31, 2023

(54) TRAFFIC MONITORING APPARATUS, TRAFFIC MONITORING SYSTEM, TRAFFIC MONITORING METHOD, AND STORAGE MEDIUM

(71) Applicant: NEC Corporation, Minato-ku, Tokyo (JP)

(72) Inventors: Masatake Takahashi, Tokyo (JP); Hitoshi Sakurai, Tokyo (JP)

(73) Assignee: NEC Corporation, Minato-ku, Tokyo (JP)

(21) Appl. No.: 18/017,466

(22) PCT Filed: Jul. 28, 2020
(86) PCT No.: PCT/JP2020/028845

§ 371 Date: Jan. 23, 2023

(51) Int. Cl. G08G 1/01; G08G 1/04; G08G 1/056; G08G 1/0967; G06V 20/54

(52) U.S. Cl. CPC G08G 1/0129; G08G 1/0133; G08G 1/04; G08G 1/056; G08G 1/096725; G06V 20/54

(57) ABSTRACT

An object is to holistically recognize a wide-area traffic condition in real time. A traffic monitoring apparatus (102) includes a position acquisition unit (106) that acquires position information indicating a vehicle position on a road, and a history generation unit (107) that generates history information indicating a change over time in the vehicle position, based on the position information. The position acquisition unit (106) acquires position information to be acquired, for example, based on optical fiber sensing utilizing an optical fiber being laid on a road. The traffic monitoring apparatus (102) may further include an abnormality detection unit (107) that detects an abnormal event on a road, based on an event-specific history pattern indicating a pattern of a change over time in a vehicle position associated with a type of the abnormal event on the road, and the change over time in the vehicle position.

### TECHNICAL FIELD

The present invention relates to a traffic monitoring apparatus, a traffic monitoring system, a traffic monitoring method, and a program.

### BACKGROUND ART

PTL 1 discloses a technique for recognizing a distribution condition of a moving body in a target section on a route from a point A to a point B. A route guiding apparatus described in PTL 1 recognizes a distribution condition of a moving body by computing, based on a detection result of a vehicle sensor, the number of moving bodies being present in each of small sections acquired by dividing a target section for each several hundred meters in a certain time cross section.

It is described that several vehicle sensors described in PTL 1 are installed in a small section to mainly detect a velocity of an automobile traveling on a road, a passing traffic volume, and the like in a road traffic, and are widely used in a field of road traffic control.

However, since a vehicle sensor (traffic counter) only acquires information on a vehicle passing through the point, it is not always a case that the vehicle sensor can accurately acquire information such as an average velocity of a vehicle in a section including the point. In view of the above, PTL 2 discloses a technique for supporting appropriate usage of probe information.

A traffic information management system described in PTL 2 computes a first traffic condition by using information acquired from a vehicle sensor installed on a road, for each of a plurality of sections of the road, and also computes a second traffic condition by using probe information acquired from a vehicle traveling on the road. Further, the traffic information management system displays, on a display unit, a first traffic condition and a second traffic condition related to a section where a difference between the first traffic condition and the second traffic condition is equal to or more than a predetermined threshold value.

### RELATED DOCUMENT

### Patent Document

[PTL 1] Japanese Patent Application Publication No. H11-203594
[PTL 2] Japanese Patent Application Publication No. 2018-190117

### SUMMARY OF THE INVENTION

### Technical Problem

Generally, since a traffic condition of a certain section of a road affects another section, it is desirable to holistically recognize a traffic condition of a moving body on the road in a wide area for road control. Further, since a traffic condition of a road changes moment by moment, for example, congestion occurs in a relatively short time when a traffic accident occurs, it is desirable to recognize the traffic condition in real time.

However, a distribution condition of a moving body in a target section to be recognized by the technique described in PTL 1 is the number of moving bodies being present in each of small sections acquired by dividing the target section, and it is difficult to holistically recognize a traffic condition of a moving body on the road in a wide area and in real time.

Further, according to the traffic information management system described in PTL 2, even when a section where a difference between a first traffic condition and a second traffic condition is equal to or more than a threshold value can be notified to a user, it is difficult to derive a traffic condition in the section, for example, an average velocity of a vehicle. Therefore, even by the technique described in PTL 2, it is difficult to holistically recognize a traffic condition of a moving body on a road in a wide area and in real time.

In view of the above-described circumstance, an object of the present invention is to provide a traffic monitoring apparatus, a traffic monitoring system, a traffic monitoring method, and a program being capable of holistically recognizing a wide-area traffic condition in real time.

### Solution to Problem

In order to achieve the above-described object, a traffic monitoring apparatus according to a first aspect of the present invention includes:
a position acquisition means for acquiring position information indicating a vehicle position on a road; and
a history generation means for generating first history information indicating a change over time in the vehicle position, based on the position information.

A traffic monitoring system according to a second aspect of the present invention includes:
the above-described traffic monitoring apparatus;
an optical fiber being laid on the road, and including one end to which termination processing of suppressing reflection of an optical signal is applied; and
a sensing apparatus for inputting an optical signal to the optical fiber, and also observing a change amount of light interference intensity being intensity of light with which pieces of back scattered light occurred accompanied by an input of the optical signal interfere with each other, wherein
the position acquisition means acquires the position information on the road to be acquired based on a change amount of the light interference intensity observed by the sensing apparatus.

A traffic monitoring method according to a third aspect of the present invention includes,

by a computer:
acquiring position information indicating a vehicle position on a road; and
generating first history information indicating a change over time in the vehicle position, based on the position information.

A program according to a fourth aspect of the present invention causes to execute:
acquiring position information indicating a vehicle position on a road; and
generating first history information indicating a change over time in the vehicle position, based on the position information.

### Advantageous Effects of Invention

The present invention enables to holistically recognize a wide-area traffic condition in real time.

### BRIEF DESCRIPTION OF THE DRAWINGS

FIG. 1 is a diagram illustrating a configuration of a traffic monitoring system according to one example embodiment of the present invention.

FIG. 2 is a diagram illustrating a functional configuration of a traffic monitoring apparatus according to one example embodiment.

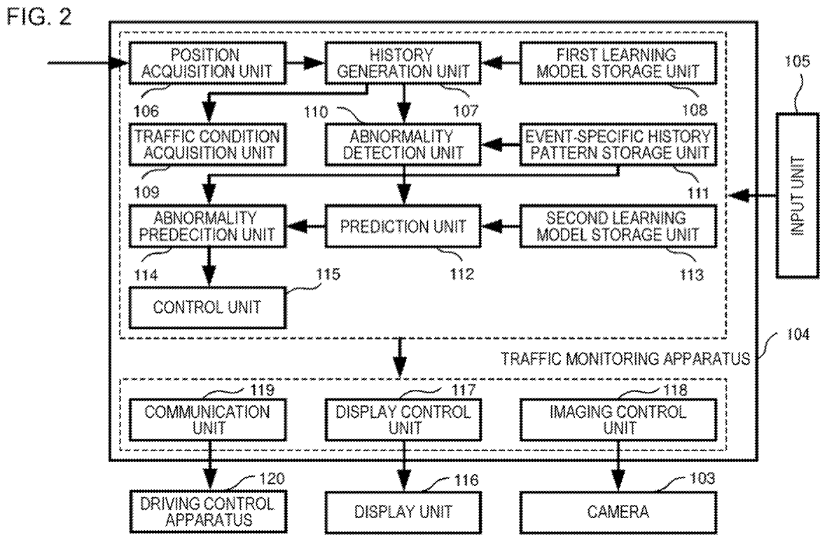

FIG. 3 is a diagram illustrating a physical configuration of the traffic monitoring apparatus according to one example embodiment.

FIG. 4A is a flowchart illustrating one example of a traffic monitoring method according to one example embodiment.

FIG. 4B is a flowchart illustrating one example of a traffic monitoring method according to one example embodiment.

FIG. 5 is a diagram illustrating a method of deriving a traffic parameter from a change over time in a vehicle position.

FIG. 6 is a diagram illustrating one example of a congestion pattern being a pattern of a change over time in a vehicle position when congestion has occurred.

FIG. 7 is a diagram illustrating one example of a stop pattern being a pattern of a change over time in a vehicle position when a stop of a vehicle has occurred.

FIG. 8 are diagrams when a road obstacle has occurred, wherein (a) is a diagram illustrating one example of an obstacle pattern being a pattern of a change over time in a vehicle position, and (b) is a diagram illustrating one example of a moving route of a vehicle traveling on a road.

FIG. 9 is a flowchart illustrating one example of traffic control processing.

FIG. 10 is a diagram illustrating a functional configuration of a history generation unit according to one modification example.

### DESCRIPTION OF EMBODIMENTS

Hereinafter, one example embodiment according to the present invention is described with reference to the drawings. In all drawings, a same element is indicated by a same reference sign. Note that, in all drawings, a similar constituent element is indicated by a similar reference sign, and description thereof is omitted as necessary.

### <Configuration of Traffic Monitoring System According to Present Example Embodiment>

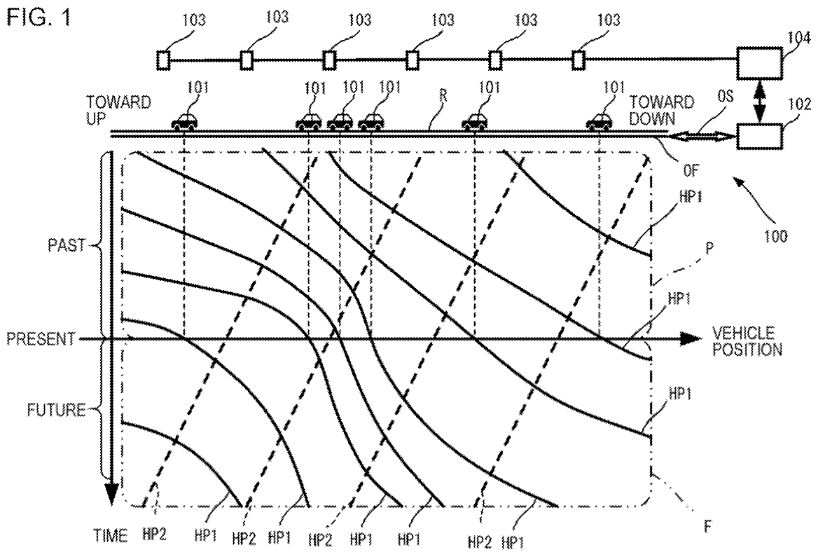

As illustrated in FIG. 1, a traffic monitoring system 100 according to a present example embodiment is a system for monitoring a traffic of a vehicle 101 traveling on a road R by utilizing an optical fiber sensing technique. The road R is typically a highway, but may be a general road other than the above. Further, the vehicle 101 is an automobile, a motorcycle, a bus, a truck, and the like.

The traffic monitoring system 100 includes an optical fiber OF, a sensing apparatus 102, a camera 103, and a traffic monitoring apparatus 104.

The optical fiber OF is an optical fiber cable laid on the road R. The optical fiber OF is generally, for example, one core among a multicore optical fiber cable for communication being laid on a shoulder portion, a median strip, or the like of a highway, and includes one end to which the sensing apparatus 102 is connected, and the other end to which termination processing of suppressing reflection of an optical signal is applied. Note that, a plurality of fiber cables among a multicore optical fiber cable may be adopted as the optical fiber OF for optical fiber sensing.

The sensing apparatus 102 inputs an optical signal to the optical fiber OF, and also observes a change amount of light interference intensity being intensity of light with which pieces of back scattered light occurred accompanied by an input of the optical signal interfere with each other.

Specifically, for example, the sensing apparatus 102 inputs an optical signal of a pulse waveform from one end of the optical fiber OF. This causes return light referred to as weak back scattered light from all positions of the optical fiber OF. The sensing apparatus 102 observes the back scattered light.

When an environmental change occurs in the vicinity of the optical fiber OF, a structure and a characteristic parameter of quartz glass composing the optical fiber change accompanied by the environmental change, and signal quality of back scattered light from a location where the change has occurred also changes.

When an optical signal having high coherence is input, and a vibration when the vehicle 101 is traveling on the road R is transmitted to the optical fiber OF, a phase state of back scattered light changes. A change in the phase state of back scattered light is observed as a change in light intensity by interference with another back scattered light received at the same time. Specifically, the sensing apparatus 102 inputs an optical signal to the optical fiber OF, and observes a change amount of light interference intensity occurred by application of a vibration.

A place of occurrence of a vibration is computed from a round-trip time from a time when an optical signal is input until back scattered light is observed, and a propagation velocity of the optical signal. An optical signal is repeatedly input at a constant frequency in such a way that back scattered light from the other end (specifically, a farthest end viewed from the sensing apparatus 102) of the optical fiber OF, and an optical signal to be input next do not mix with each other. This allows transition of an environmental change such as a vibration occurring in the vicinity of the optical fiber OF to be accurately observed in real time.

In this way, optical fiber sensing is a technique for detecting a place of occurrence of a vibration and the like with use of the optical fiber OF as a sensing medium. In the technique, since a general optical fiber OF being a transmission medium of communication data can be utilized as a linear-shaped passive sensor, a wide-area traffic condition can be recognized in real time without installing a new sensor or the like.

The camera 103 is one example of an imaging means for photographing the road R to recognize a traffic condition of the road R. The camera 103 is, for example, a closed-circuit television (CCTV) camera, or the like to be installed on the road R with a certain interval.

The traffic monitoring apparatus 104 repeatedly acquires, from the sensing apparatus 102, observation information including a place of occurrence of a vibration on the road R. The place of occurrence of a vibration is associated with a position (vehicle position) of the vehicle 101 on the road R. Therefore, observation information includes position information indicating a vehicle position.

The traffic monitoring apparatus 104 derives, from repeatedly acquired position information, a change over time in a vehicle position. Further, the traffic monitoring apparatus 104 performs, based on the change over time in the vehicle position, a traffic control support and the like including computation of a traffic parameter indicating a traffic condition of a road, detection of an abnormal event occurred on the road R, prediction of a change over time in a future vehicle position and prediction of occurrence of an abnormal event, and presentation of a traffic control means.

As an example of an abnormal event, congestion, a stop of a vehicle, and a road obstacle can be mentioned. The road obstacle is that an object (e.g., a vehicle parked in an accident, a fallen cargo, and a flying object due to strong wind) becoming an obstacle against traveling of the vehicle 101 is present on a road.

As an example of a traffic parameter, a velocity of the vehicle 101 traveling on the road R, traffic density of the road R, a traffic volume being a volume of the vehicle 101 traveling a predetermined point on the road R per unit time, and an occupancy indicating a ratio with which the road R is occupied by the vehicle 101 can be mentioned.

A change over time in a vehicle position is indicated by a diagram as illustrated in FIG. 1, in which the vehicle position is denoted by a horizontal axis, and time is denoted by a vertical axis.

A solid line HP1 illustrated in FIG. 1 indicates a change over time in a vehicle position related to the vehicle 101 traveling on an up lane, and a dotted line HP2 indicates a change over time in a vehicle position related to the vehicle 101 traveling on an unillustrated down lane.

Further, the solid line HP1 and the dotted line HP2 within an area surrounded by a dashed line P are an example of a change over time in a vehicle position from past to present. A change over time in a vehicle position from past to present, specifically, information indicating a history on a vehicle position is referred to as history information.

The solid line HP1 and the dotted line HP2 within an area surrounded by a double-dotted line F are an example of a change over time in a future vehicle position to be predicted. Information indicating a change over time in a future vehicle position to be predicted is referred to as prediction information.

In the present example embodiment, an example is described in which history information on the vehicle 101 directed in one direction (vehicle 101 traveling on an up lane) is generated. Further, an example in which acquisition of a traffic parameter, detection of an abnormal event, prediction of a change over time in a vehicle position, prediction of occurrence of an abnormal event, presentation of a traffic control means, and the like are performed based on the generated history information is described.

Note that, regarding the vehicle 101 traveling in an opposite direction, similarly to the above, a traffic parameter, detection of an abnormal event, prediction of a change over time in a vehicle position and prediction of occurrence of an abnormal event, and presentation of a traffic control means can be performed based on a change over time in a vehicle position of the vehicle 101 traveling in the opposite direction.

### <Functional Configuration of Traffic Monitoring Apparatus According to Present Example Embodiment>

The traffic monitoring apparatus 104 according to the present example embodiment includes an input unit 105, a position acquisition unit 106, a history generation unit 107, a first learning model storage unit 108, a traffic condition acquisition unit 109, an abnormality detection unit 110, an event-specific history pattern storage unit 111, a prediction unit 112, a second learning model storage unit 113, an abnormality prediction unit 114, a control unit 115, a display unit 116, a display control unit 117, an imaging control unit 118, and a communication unit 119.

The input unit 105 is a keyboard, a mouse, a touch panel, and the like for allowing a user to input an instruction and the like.

The position acquisition unit 106 acquires, from the sensing apparatus 102, position information on the road R to be acquired based on optical fiber sensing utilizing the optical fiber OF being laid on the road R.

Specifically, the position acquisition unit 106 repeatedly acquires, from the sensing apparatus 102, position information on the road R to be acquired based on a change amount of light interference intensity observed by the sensing apparatus 102.

Note that, in the present example embodiment, description is made by an example in which position information is acquired based on optical fiber sensing, but position information may be acquired based on information to be acquired from each type of a sensor to be installed on the road R, such as a CCTV camera, a traffic volume meter (coil), or the like. Further, position information may be acquired based on probe information or the like of an electronic toll collection system (ETC) 2.0.

The history generation unit 107 generates history information indicating a change over time in a vehicle position from past to present, based on position information to be acquired by the position acquisition unit 106.

Specifically, as described above, position information is included in observation information to be acquired based on an optical signal to be input at a constant frequency. Therefore, position information to be repeatedly acquired by the position acquisition unit 106 indicates a discrete vehicle position, regardless of a relatively short time interval.

The history generation unit 107 generates history information in which a change over time in a vehicle position is continuously indicated as illustrated by the line HP1 in FIG. 1 according to a first learning model by using, as an input, a discrete vehicle position.

Note that, the history generation unit 107 may generate, by deriving an approximate curve or an approximate straight line of a discrete vehicle position, or combination thereof, history information indicating the derived approximate curve, approximate straight line, or combination thereof. The first learning model storage unit 108 is a storage unit for storing in advance a first learning model to be referred to by the history generation unit 107.

The first learning model is a learned learning model that has performed machine learning in which history information is generated by using, as an input, position information included in observation information from the sensing apparatus 102. For learning of the first learning model, it is preferable to adopt supervised learning. Training data in this case may be generated based on probe information, an in-vehicle camera, or the like of the vehicle 101 that has actually travelled.

The traffic condition acquisition unit 109 derives a value of a traffic parameter, based on history information.

The abnormality detection unit 110 detects an abnormal event on the road R, based on a change over time in a vehicle position indicated by history information generated by the history generation unit 107, and an event-specific history pattern.

The event-specific history pattern indicates a pattern of a change over time in a vehicle position associated with a type of an abnormal event on the road R.

The event-specific history pattern storage unit 111 is a storage unit for storing in advance event-specific history pattern information indicating an event-specific history pattern, and is referred to by the abnormality detection unit 110.

In a case where an abnormal event is detected by the abnormality detection unit 110, the prediction unit 112 generates prediction information regarding the road R, based on a type of the detected abnormal event, and history information generated by the history generation unit 107. For example, the prediction unit 112 outputs prediction information regarding the road, based on a second learning model by using, as an input, history information generated by the history generation unit 107, and a type of an abnormal event detected by the abnormality detection unit 110.

The second learning model storage unit 113 is a storage unit for storing in advance a second learning model to be referred to by the prediction unit 112.

The second learning model is a learned learning model that has performed machine learning in which prediction information is generated by using, as an input, first history information for training, and a type of a detected abnormal event. For learning of the second learning model, it is preferable to adopt supervised learning. For training data in this case, it is preferable to adopt data indicating past history information that has been actually generated, and a type of an abnormal event.

Note that, regardless of whether an abnormal event is detected by the abnormality detection unit 110, the prediction unit 112 may output, based on history information generated by the history generation unit 107, prediction information indicating a change over time in a vehicle position to be predicted regarding the road R. The prediction unit 112 in this case may generate prediction information regarding the road R, based on a second learning model by using, as an input, history information generated by the history generation unit 107.

The second learning model in this case is a learned learning model that has performed machine learning in which prediction information is generated by using, as an input, first history information for training. For learning of the second learning model, it is preferable to adopt supervised learning. For training data in this case, it is preferable to adopt data including past history information that has been actually generated.

The abnormality prediction unit 114 predicts a type of an abnormal event occurring on the road R, based on a change over time indicated by prediction information generated by the prediction unit 112, and an event-specific history pattern. The event-specific history pattern is a pattern indicated by event-specific history pattern information stored in the event-specific history pattern storage unit 111.

Specifically, whereas the above-described abnormality detection unit 110 adopts history information, as information indicating a change over time in a vehicle position, the abnormality prediction unit 114 adopts prediction information, as information indicating a change over time in a vehicle position. Except for this point, functions of the abnormality prediction unit 114 and the abnormality detection unit 110 may be similar to each other.

In a case where occurrence of an abnormal event is predicted by the abnormality prediction unit 114, the control unit 115 generates traffic control information, based on a type of an abnormal event whose occurrence is predicted. The traffic control information includes a traffic control means, and the like for alleviating an abnormal event whose occurrence is predicted.

The traffic control means includes, for example, at least one of a closure of an interchange, another route for avoiding a point of occurrence of an abnormal event whose occurrence is predicted, a toll change of a road, and a dispatch plan of an emergency personnel. The dispatch plan of an emergency personnel is a plan related to dispatch of a personnel for handling an abnormal event, and includes the number of the personnel, the number of emergency vehicles, an arrangement of an emergency vehicle directed to a site, an estimated time of arrival, and the like.

For example, the control unit 115 generates, based on a learning model, by using, as an input, a type of an abnormal event whose occurrence is predicted by the abnormality prediction unit 114, and history information, traffic control information including a traffic control means for alleviating the abnormal event.

As the learning model, it is preferable to store in advance, in an unillustrated storage unit, a learned learning model that has performed machine learning in which traffic control information including a traffic control means for alleviating the abnormal event is generated by using, as an input, a type of a past abnormal event, and history information. For learning, it is preferable to adopt supervised learning, and for training data, it is preferable to adopt traffic control information including a traffic control means that has been effective to alleviate the abnormal event, by using, as an input, a type of a past abnormal event, and history information.

Note that, the control unit 115 may hold in advance control information in which, for example, a type of an abnormal event, and a traffic control means are associated with each other, regardless of a learning model. In this case, the control unit 115 may acquire, from control information, a traffic control means with which a type of an abnormal event whose occurrence is predicted is associated, and generate traffic control information including the acquired traffic control means.

Further, the control means 115 holds in advance performance information.

The performance information includes a traffic control means that has been adopted in the past for each type of an abnormal event, and an evaluation with respect to the traffic control means. The evaluation is represented, for example, by an evaluation value indicating a degree by which an abnormal event is alleviated by the traffic control means, or determination as to whether an abnormal event is alleviated by the traffic control means.

Further, the control unit 115 generates evaluation information with respect to a traffic control means generated by the control unit 115, based on performance information. The evaluation information indicates an evaluation value indicating a predicted degree by which an abnormal event whose occurrence is predicted by the abnormality prediction unit 114 is alleviated by a traffic control means generated by the control unit 115, or determination as to whether the abnormal event is predicted to be alleviated by the traffic control means.

Further, the control unit 115 accepts a traffic control means to be selected by a user from among traffic control means indicated by traffic control information generated by the control unit 115, and generates decision information indicating the selected traffic control means.

The display unit 116 displays a screen. The display control unit 117 causes the display unit 116 to display a screen.

The display control unit 117 causes to display, on a screen of the display unit 116, for example, history information, a value of a traffic parameter, prediction information, a road map indicating a place of occurrence of a present or future abnormal event, presentation of a traffic control means, traffic control information to be generated by the control unit 115, evaluation information, decision information, and the like.

The imaging control unit 118 controls the camera 103 for photographing the road R.

For example, in a case where an abnormal event is detected by the abnormality detection unit 110, the imaging control unit 118 causes the camera 103 to photograph a place of occurrence of the abnormal event in an enlarged manner. For example, in a case where occurrence of an abnormal event is predicted by the abnormality prediction unit 114, the imaging control unit 118 causes the camera 103 to photograph a place where occurrence of the abnormal event is predicted in an enlarged manner.

For example, by displaying, on a screen of the display unit 116, a photographed image of the camera 103 under the control of the display control unit 117, it is possible to recognize a current condition of a place of occurrence of an abnormal event or a place where occurrence is predicted.

The communication unit 119 communicates with a driving control apparatus 120 loaded in the vehicle 101. The driving control apparatus 120 is desirably an apparatus for controlling automatic driving of the vehicle 101.

For example, in a case where an abnormal event is detected by the abnormality detection unit 110, the communication unit 119 transmits, to the driving control apparatus 120, information indicating a place of occurrence of the abnormal event. For example, in a case where occurrence of an abnormal event is predicted by the abnormality prediction unit 114, the communication unit 119 transmits, to the driving control apparatus 120, information indicating a place of occurrence of an abnormal event whose occurrence is predicted. For example, the communication unit 119 transmits, to the driving control apparatus 120, decision information to be generated by the control unit 115.

### <Physical Configuration of Image Analysis Apparatus According to Present Example Embodiment>

Hereinafter, an example of a physical configuration of the traffic monitoring apparatus 102 according to the present example embodiment is described with reference to a drawing.

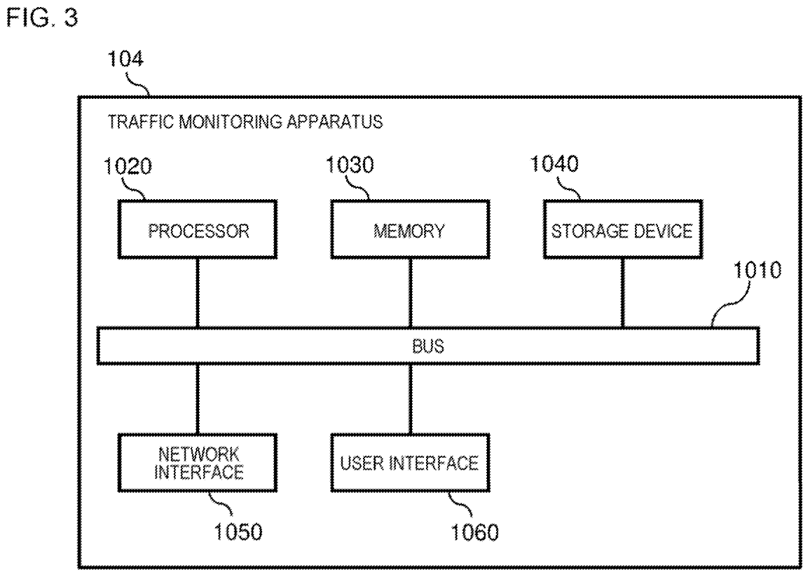

As illustrated in FIG. 3, the traffic monitoring apparatus 102 physically includes a bus 1010, a processor 1020, a memory 1030, a storage device 1040, a network interface 1050, and a user interface 1060.

The bus 1010 is a data transmission path along which the processor 1020, the memory 1030, the storage device 1040, the network interface 1050, and the user interface 1060 mutually transmit and receive data. However, a method of mutually connecting to the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like.

The storage device 1040 achieves a storage unit (the first learning model storage unit 108, the event-specific history pattern storage unit 111, and the second learning model storage unit 113) of the traffic monitoring apparatus 102 or a function of holding information.

Further, the storage device 1040 stores a program module achieving each functional unit (the position acquisition unit 106, the history generation unit 107, the traffic condition acquisition unit 109, the abnormality detection unit 110, the prediction unit 112, the abnormality prediction unit 114, the control unit 115, the display control unit 117, the imaging control unit 118, and the communication unit 119) of the image analysis apparatus 102. The processor 1020 achieves each functional unit associated with the program module by reading each program module in the memory 1030 and executing each program module.

The network interface 1050 is an interface for connecting the traffic monitoring apparatus 102 to a wired network, a wireless network, or a network constituted by combining these. The traffic monitoring apparatus 102 according to the present example embodiment communicates with the sensing apparatus 102, the camera 103, and the driving control apparatus 120 by being connected to a network via the network interface 1050.

The user interface 1070 is an interface to which information is input from a user and an interface for presenting information to a user, and includes, for example, a mouse, a keyboard, a touch sensor, and the like as the input unit 105, and a liquid crystal display and the like as the display unit 116.

In this way, a function of the traffic monitoring apparatus 102 can be achieved by executing a software program in cooperation with each physical constituent element. Therefore, the present invention may be achieved as a software program (hereinafter, also simply referred to as a “program”), or may be achieved as a non-transitory storage medium recorded with the program.

### <Traffic Monitoring Processing According to Present Example Embodiment>

Hereinafter, traffic monitoring processing according to one example embodiment of the present invention is described with reference to the drawings.

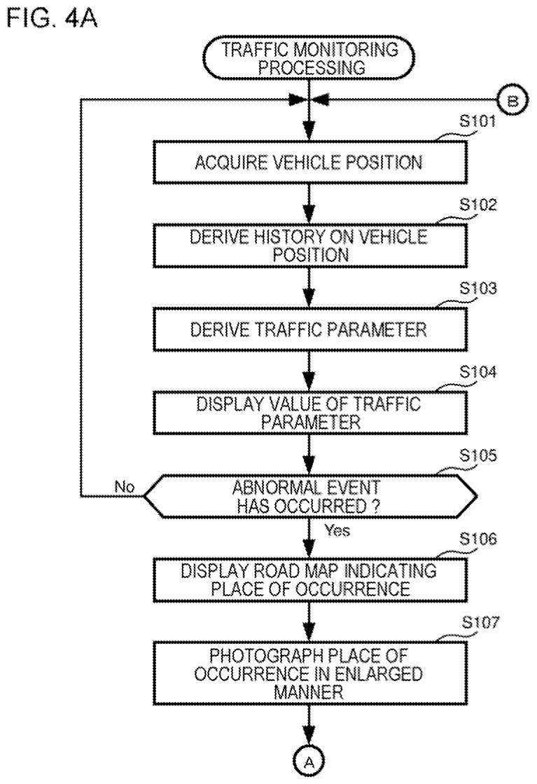

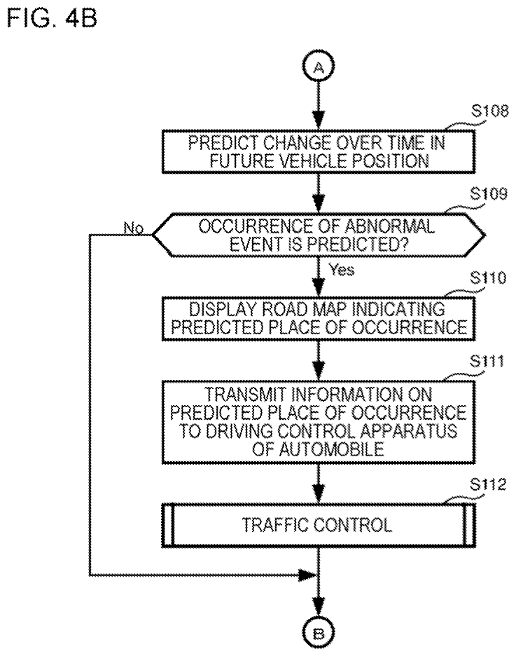

FIGS. 4A and 4B are flowcharts illustrating one example of the traffic monitoring processing according to the present example embodiment.

The traffic monitoring processing is processing for monitoring a traffic on the road R, and is performed by referring to position information to be repeatedly acquired from the sensing apparatus 102, for example, at a constant time interval. The traffic monitoring processing is started, for example, in response to receiving a user instruction from the input unit 103.

As illustrated in FIG. 4A, the position acquisition unit 106 acquires a vehicle position of the vehicle 101 traveling on the road R by acquiring position information from the sensing apparatus 102 (step S101).

The history generation unit 107 derives a change over time in a vehicle position from past to present, specifically, a history on a vehicle position, based on a vehicle position acquired in step S101 (step S102).

Herein, since a vehicle position can be acquired at a relatively short cycle in step S101, the history generation unit 107 may be performed, when a vehicle position within a predetermined time longer than an acquisition cycle of the vehicle position is acquired in step S101.

The traffic condition acquisition unit 109 derives, based on a history on a vehicle position derived in step S102, a traffic parameter on the road R, such as a velocity (vehicle velocity) of the vehicle 101, traffic density, a traffic volume, and an occupancy (step S103).

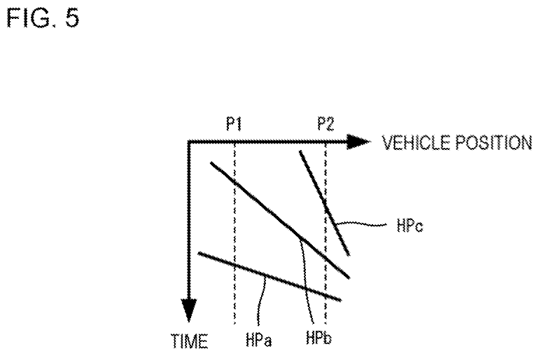

As is clear from referring to an example of a change over time in a vehicle position in FIG. 5, a vehicle velocity [km/h] is derived by dividing a change amount of the vehicle position (in FIG. 5, for example, a distance from a vehicle position P1 to a vehicle position P2) by a time required for the change. In FIG. 5, the vehicle velocity is expressed by a gradient of a change over time in a vehicle position, and among lines HPa, HPb, and HPc indicating a change over time in a vehicle position, the vehicle 101 associated with the line HPa is fastest, and the vehicle 101 associated with the line HPc is slowest.

The traffic density [vehicle number/km] is the vehicle number of vehicles 101 per unit section at a certain moment of time. In FIG. 5, the traffic density [vehicle number/km] is expressed by the number of the lines HPa, HPb, and HPc indicating a change over time in a vehicle position and intersecting, in a case where a horizontal line associated with a certain time is drawn, the horizontal line within an area associated with a unit section.

The traffic volume [vehicle number/h] is the vehicle number of vehicles 101 passing through a certain point within a unit time. In FIG. 5, the traffic volume [vehicle number/h] is expressed by the number of the lines HPa, HPb, and HPc indicating a change over time in a vehicle position and intersecting, in a case where a vertical line associated with a certain point is drawn, the vertical line within an area associated with a unit time.

The occupancy is a ratio (space occupancy) of a distance occupied by the vehicle 101 within a target section at a certain moment of time, or a ratio (time occupancy) of a time occupied by the vehicle 101 within a target time at a certain point. These can be derived based on traffic density, a traffic volume, or the like, for example, when it is assumed that a length (vehicle length) of the vehicle 101 is an average length.

The display control unit 117 causes the display unit 116 to display a value of a traffic parameter derived in step S103 (step S104).

The abnormality detection unit 110 detects an abnormal event occurring on the road R, based on a history on a vehicle position derived in step S102, and an event-specific history pattern indicated by event-specific history pattern information stored in the event-specific history pattern storage unit 111. Then, the abnormality detection unit 110 discriminates whether an abnormal event has occurred on the road R, based on a detection result (step S105).

Specifically, for example, an event-specific history pattern includes at least one of a congestion pattern associated with congestion, a stop pattern associated with a stop of a vehicle, and an obstacle pattern associated with a road obstacle.

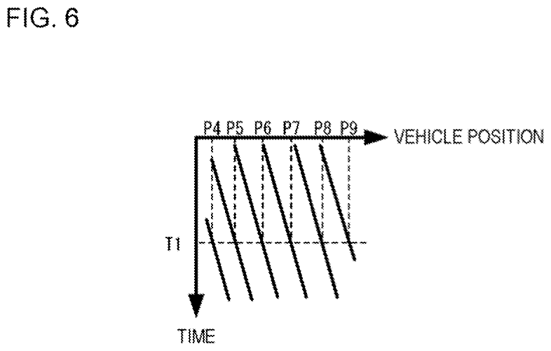

FIG. 6 illustrates one example of a congestion pattern being a pattern of a change over time in a vehicle position when congestion has occurred. When congestion occurs, the vehicle 101 travels at a lower velocity than a reference velocity to be determined as necessary, and a vehicle distance between the vehicles 101 becomes shorter than a reference distance to be determined as necessary. Therefore, as illustrated in FIG. 6, a congestion pattern includes, in a feature thereof, that a gradient of a line indicating a change in a vehicle position of each vehicle 101 indicates a slow velocity, or that a distance between vehicle positions P4 to P9 of each vehicle 101 is short at a time T1.

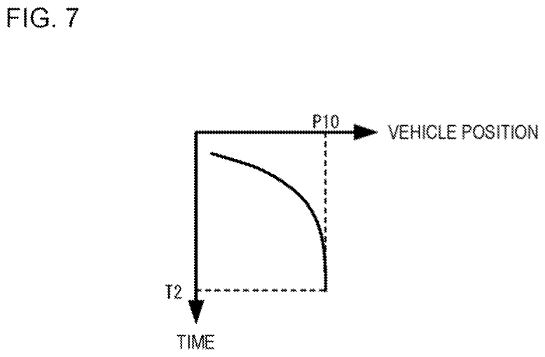

FIG. 7 illustrates one example of a stop pattern being a pattern of a change over time in a vehicle position when a stop of the vehicle 101 has occurred. When a stop of the vehicle 101 occurs, since a vehicle position of the vehicle 101 does not change even when time elapses, a stop pattern includes a feature that a vehicle position is constant even when time elapses. In the example in FIG. 7, the vehicle 101 gradually decelerates, and stops at a vehicle position P10 at a time T2. Note that, a stop pattern may include that a stop is continued for a longer time than a predetermined time.

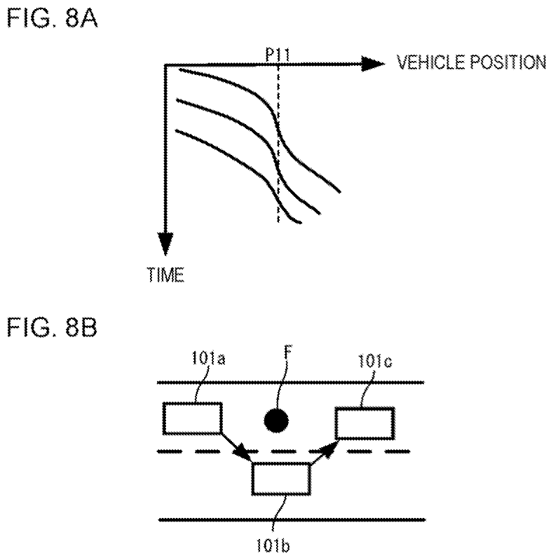

FIG. 8(a) illustrates one example of an obstacle pattern being a pattern of a change over time in a vehicle position when a road obstacle has occurred.

For example, as illustrated in FIG. 8(b), it is assumed that a road obstacle F is present at a position P11 on a driving lane on the road R. In this case, the vehicle 101 traveling on the driving lane decelerates from a position 101a in front of the road obstacle F in order to move to an adjacent lane and avoid the road obstacle F. Further, when moved to a position 101b on the adjacent lane, and passes by the road obstacle F, the vehicle 101 returns to the driving lane, and accelerates, as illustrated in FIG. 8(b).

In a case where the road obstacle F is present on a driving lane on the road R, the obstacle pattern in FIG. 8(a) includes a feature that a plurality of the vehicles 101 accelerate after traveling at a slow velocity within a predetermined range from the road obstacle F. Note that, an obstacle pattern may include deceleration to a velocity slower than a predetermined velocity in order to discriminate whether deceleration on the road R is deceleration for avoiding the road obstacle F.

Herein, each of event-specific history patterns illustrated in FIGS. 6 to 8 are merely one example of an event-specific history pattern associated with each type of an abnormal event such as congestion, a stop of the vehicle 101, and a road obstacle. Event-specific history pattern information including a plurality of event-specific history patterns for each type of an abnormal event may be stored in advance in the event-specific history pattern storage unit 111. Further, the abnormality detection unit 110 derives, by collating (e.g., pattern matching) between each event-specific history pattern with a history on a vehicle position, a degree of similarity therebetween.

In a case where a degree of similarity is more than a predetermined threshold value, since the abnormality detection unit 110 detects an abnormality event occurring on the current road R, the abnormality detection unit 110 discriminates that an abnormal event has occurred on the road R (step S105; Yes). At this occasion, a type of an abnormal event occurring on the road R is also determined from a type of an abnormal event associated with an event-specific history pattern whose degree of similarity is large.

Further, in a case where a degree of similarity is equal to or less than the threshold value, since the abnormality detection unit 110 does not detect an abnormal event occurring on the current road R, the abnormality detection unit 110 discriminates that an abnormal event has not occurred on the road R (step S105; No).

Note that, as described above, regarding an event-specific history pattern, various patterns are presumed for each event. In view of the above, the abnormality detection unit 110 may detect an abnormal event, based on a learning model by using, as an input, a change over time in a vehicle position, and in a case where an abnormal event is detected, the abnormality detection unit 110 may generate information indicating a type of the abnormal event. As a learning model in this case, it may be preferable to adopt a learned learning model that has performed machine learning in which, by using, as an input, a change over time in a vehicle position, information indicating a type of an abnormal event according to a degree of similarity between the change, and an event-specific history pattern is generated. The learning may be supervised learning, and a learning model may be stored in advance in a storage unit, in place of the event-specific history pattern storage unit 111.

Further, the abnormality detection unit 110 may detect an abnormal event according to determination as to whether one or a plurality of features of an event-specific history pattern for each type of an abnormal event are included in a change over time in a vehicle position, and determine a type of the detected abnormal event.

In a case where it is discriminated that an abnormal event has not occurred (step S105; No), the position acquisition unit 106 performs processing in step S101.

In a case where it is discriminated that an abnormal event has occurred (step S105; Yes), the display control unit 117 causes a screen of the display unit 116 to display a road map indicating a place of occurrence of the abnormal event (step S106). Further, the imaging control unit 118 causes the camera 103 to photograph the place of occurrence of the abnormal event in an enlarged manner (step S107).

Hereinafter, FIG. 4B is referred to.

The prediction unit 112 predicts a change over time in a future vehicle position regarding the road R, based on a history on a vehicle position derived in step S102, and a type of an abnormal event detected in step S105 (step S108).

Herein, a change over time in a future vehicle position to be predicted is, for example, a change over time in a vehicle position indicated by the solid line HP1 within an area surrounded by the double-dotted line F in FIG. 1.

FIG. 4B is referred to.

The abnormality prediction unit 114 predicts an abnormal event occurring on the road R, based on a change over time in a future vehicle position predicted in step S108, and an event-specific history pattern indicated by event-specific history pattern information stored in the event-specific history pattern storage unit 111. Then, the abnormality prediction unit 114 discriminates whether occurrence of an abnormal event on the road R is predicted based on a prediction result (step S109).

A method of predicting occurrence of an abnormal event in step S109 is substantially similar to the one in which a history on a vehicle position in processing in step S105 is replaced by a change over time in a future vehicle position.

Then, also in step S109, in a case where a degree of similarity is more than a predetermined threshold value similarly to step S105, the abnormality prediction unit 114 discriminates that occurrence of an abnormal event on the road R is predicted (step S109; Yes). At this occasion, a type of an abnormal event whose occurrence on the road R is predicted is also determined from a type of an abnormal event with which an event-specific history pattern whose degree of similarity is large is associated.

Further, in a case where the degree of similarity is equal to or less than the threshold value, the abnormality prediction unit 114 discriminates that occurrence of an abnormal event on the road R is not predicted (step S109; No).

In a case where it is discriminated that occurrence of an abnormal event is not predicted (step S109; No), the position acquisition unit 106 performs processing in step S101 by referring to FIG. 4A again.

Referring back to FIG. 4B, in a case where it is discriminated that occurrence of an abnormal event is predicted (step S109; Yes), the display control unit 117 causes a screen of the display unit 116 to display a road map indicating a predicted place of occurrence being a place where occurrence of an abnormal event is predicted (step S110). Further, the communication unit 119 transmits, to the driving control apparatus 120, information on a predicted place of occurrence indicating a predicted place of occurrence of the abnormal event (step S111).

The control unit 115 performs traffic control processing (step S112) for traffic control for alleviating an abnormal event occurring at a current time, and a future abnormal event whose occurrence is predicted.

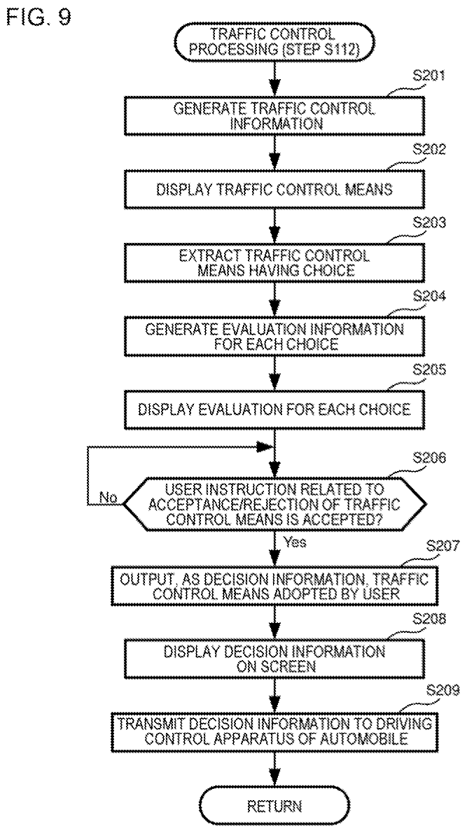

FIG. 9 is a flowchart illustrating details of traffic control processing (step S112).

The control unit 115 generates traffic control information, based on a type of an abnormal event whose occurrence is determined to be predicted in step S109 (step S201). The display control unit 117 causes the display unit 116 to display traffic control information generated in step S201 (step S202).

For example, it is assumed that an abnormal event whose occurrence is predicted is congestion. In this case, a traffic control means included in traffic control information is a closure of an interchange in front of a predicted place of occurrence of congestion, a temporary price increase of a toll at a toll gate, presentation of another route for avoiding the predicted place of occurrence, and the like. Another route may be searched based on map information and a predicted place of occurrence.

Further, in a case where congestion accompanied by a traffic accident is predicted, a traffic control means included in traffic control information may include a dispatch plan of an emergency personnel for handling the traffic accident.

The control unit 115 extracts a traffic control means having a choice from among traffic control means included in traffic control information generated in step S201 (step S302).

As a traffic control means having a choice, an example in which a plurality of other routes are presented as a traffic control means can be mentioned.

The control unit 115 generates evaluation information for each choice, regarding a traffic control means extracted in step S302 (step S204). The display control unit 117 causes the display unit 116 to display evaluation information generated in step S204 (step S205).

The control unit 115 determines whether a user instruction related to acceptance/rejection of a traffic control means displayed in step S202 is accepted (step S206). In a case where it is determined that a user instruction is not accepted (step S206; No), the control unit 115 continues processing in step S205 until the instruction is accepted.

In a case where it is determined that a user instruction is accepted (step S206), the control unit 115 outputs, as decision information, a traffic control means adopted by a user (step S207).

Specifically, a user can select a traffic control means to be actually adopted by referring to a traffic control means displayed in step S202, and an evaluation displayed in step S205. Further, by instructing the traffic control means to be adopted from the input unit 105, the control unit 115 generates decision information including the traffic control means to be adopted.

Note that, pieces of processing from steps S204 to S205 may be performed regarding all or a predetermined part of traffic control means included in traffic control information generated in step S201 without performing processing in step S203.

The display control unit 117 causes the display unit 116 to display decision information output in step 207 (step S208). A notification unit 119 transmits the decision information to the driving control apparatus 120 of an automobile (step S209).

Herein, an automobile in which the driving control apparatus 120 to which decision information is transmitted in step S109 is one example of the vehicle 101, and is desirably an automobile of automatic driving. This allows the driving control apparatus 120 to control traveling of an automobile by deriving a desirable driving route while referring to decision information.

When the traffic control processing (step S112) is finished, as illustrated in FIGS. 4B and A, the position acquisition unit 106 performs processing in step S101. The traffic control processing is continuously performed, for example, until a finishing instruction by a user is accepted from the input unit 105.

So far, one example embodiment according to the present invention has been described.

According to the present example embodiment, history information indicating a change over time in a vehicle position is generated based on position information indicating a vehicle position on a road.

As far as a position is a vehicle position on a road, the vehicle position can be recognized from a sensor or the like to be installed in a wide area. Further, by history information, a change over time in a vehicle position being continued placewise and timewise can be recognized.

Therefore, it becomes possible to holistically recognize a wide-area traffic condition in real time.

According to the present example embodiment, an abnormal event occurring on the road R is detected based on an event-specific history pattern, and a change over time in a vehicle position.

By utilizing a change over time in a vehicle position, an abnormal event occurring on the road R can be recognized in real time. Further, since a change over time in a vehicle position has a characteristic pattern for each type of an abnormal event, an abnormal event occurring on the road R can be accurately detected by detecting an abnormal event by using an event-specific history pattern.

Therefore, it becomes possible to accurately recognize an abnormal event occurring on the road R in real time.

According to the present example embodiment, a road map indicating a place of occurrence of an abnormal event is displayed on a screen. This allows a user to easily recognize a place of occurrence. Further, a place of occurrence is photographed by the camera 103 in an enlarged manner. This allows a user to accurately recognize a current condition of a place of occurrence in real time.

According to the present example embodiment, a change over time in a vehicle position on the road R is predicted based on history information indicating a change over time in a vehicle position.

Since it is often a case that the vehicle 101 that makes a similar position change in a similar road condition also makes a similar position change in future, it is possible to accurately predict a change over time in a vehicle position on the road R, based on history information. It becomes possible to holistically and accurately predict a wide-area traffic condition.

According to the present example embodiment, an abnormal event occurring on the road R is predicted based on a change over time in a vehicle position to be predicted on the road R, an event-specific history pattern, and a change over time in a vehicle position.

As described above, a change over time in a vehicle position to be predicted on the road R may be holistically and accurately predicted in a wide area. Further, similarly to a case where an abnormal event currently occurring is detected, since a change over time in a vehicle position has a characteristic pattern for each type of an abnormal event, an abnormal event occurring on the road R can be accurately predicted by using an event-specific history pattern.

Therefore, it becomes possible to accurately predict an abnormal event occurring on the road R.

According to the present example embodiment, a road map indicating a predicted place of occurrence of an abnormal event is displayed on a screen. This allows a user to easily recognize a predicted place of occurrence. Further, the predicted place of occurrence is transmitted to the driving control apparatus 120. Since this enables to make a driving plan taking into consideration a predicted place of occurrence, efficient moving is enabled by avoiding a congested place on the road R or the like.

According to the present example embodiment, traffic control information including a traffic control means for alleviating an abnormal event whose occurrence is predicted is generated based on a type of the abnormal event. Since this enables to alleviate an abnormal event, efficient moving utilizing the road R is enabled.

According to the present example embodiment, evaluation information with respect to a traffic control means is generated based on performance information of the traffic control means adopted to an abnormal event in the past. This allows a user to select a traffic control means for alleviating a current or future abnormal event by referring to an evaluation based on a past performance. Therefore, since a possibility of selecting an effective traffic control means is increased, more efficient moving utilizing the road R is enabled.

According to the present example embodiment, decision information indicating a traffic control means selected by a user is displayed on a screen. This allows a user to easily recognize decision information. Further, decision information is transmitted to the driving control apparatus 120. Since this enables to make a driving plan taking into consideration decision information, efficient moving is enabled by avoiding a congested place on the road R or the like.

### Modification Example

In the example embodiment, an example in which history information on a vehicle 101 directed in one direction is generated has been described. However, as described with reference to FIG. 1, in history information, a traveling direction of the vehicle 101 can be easily discriminated by a positive or negative sign of a gradient, or a direction toward and away from a reference position. In a present modification example, an example of a history generation unit for acquiring history information on the vehicle 101 (e.g., the vehicle 101 traveling on each of an up lane and a down lane) directed in a different direction is described.

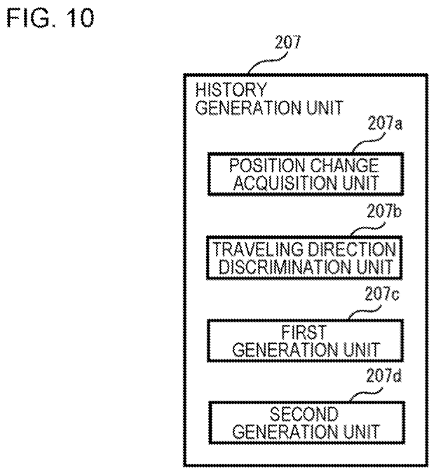

A history generation unit 207 according to the modification example functionally includes, as illustrated in FIG. 10, a position change acquisition unit 207a, a traveling direction discrimination unit 207b, a first generation unit 207c, and a second generation unit 207d.

The position change acquisition unit 207a derives a change over time in a vehicle position, based on repeatedly acquired position information.

The traveling direction discrimination unit 207b discriminates whether a traveling direction of the vehicle 101 is a first direction, or a second direction opposite to the first direction, based on a change over time derived by the position change acquisition unit 207a.

The first generation unit 207c generates first history information indicating a history on a vehicle position related to the vehicle 101 traveling in the first direction.

The second generation unit 207d generates second history information indicating a history on a vehicle position related to the vehicle 101 traveling in the second direction.

The history generation unit 207 described above may be adopted in a traffic monitoring apparatus 104 according to the example embodiment, in place of a history generation unit 107.

According to the present modification example, since the vehicle 101 traveling on each of opposing lanes can be recognized, it becomes possible to holistically recognize a wide-area traffic condition in real time.

Further, for example, since a traveling direction of the vehicle 101 traveling backwards is the same as the traveling direction of the vehicle 101 traveling on an opposite lane, for example, a positive or negative sign of a gradient of lines HP1 and HP2 included in history information illustrated in FIG. 1 becomes the same.

In view of the above, in order to distinguish the vehicle 101 traveling on an opposite lane, and the vehicle 101 traveling backwards, signal intensity of return light to be observed in optical fiber sensing may be utilized.

For example, in a case of vibration application on a lane near an optical fiber OF, signal intensity increases, and in a case of vibration application on a lane far from the optical fiber OF, signal intensity decreases. Therefore, by utilizing signal intensity by optical fiber sensing, it becomes possible to discriminate on which lane, each vehicle 101 is traveling, thereby it is possible to recognize a condition of an opposite lane, and detect a vehicle traveling backwards.

Note that, a method of discriminating on which lane, each vehicle 101 is traveling is not limited to the above-described method utilizing signal intensity by optical fiber sensing, and another method may be adopted.

As described above, while the example embodiment and the modification example according to the present invention have been described, however, the present invention is not limited thereto. For example, the present invention includes a form in which a part or all of the example embodiment and the modification example described so far are appropriately combined, and a form in which an alteration is appropriately added to the form.

One means or all means of the above-described example embodiment may also be described as the following supplementary notes, but is not limited to the following.

1. A traffic monitoring apparatus including:
a position acquisition means for acquiring position information indicating a vehicle position on a road; and
a history generation means for generating first history information indicating a change over time in the vehicle position, based on the position information.
   2. The traffic monitoring apparatus according to above-described supplementary note 1, wherein
the position acquisition means acquires the position information on the road to be acquired based on optical fiber sensing utilizing an optical fiber being laid on the road.
   3. The traffic monitoring apparatus according to above-described supplementary note 1 or 2, further including
an abnormality detection means for detecting, based on an event-specific history pattern indicating a pattern of a change over time in a vehicle position associated with a type of an abnormal event on a road, and a change over time in the vehicle position indicated by the first history information, the abnormal event on the road.
   4. The traffic monitoring apparatus according to above-described supplementary note 3, wherein
the event-specific history pattern includes at least one of a congestion pattern associated with congestion as the abnormal event, a stop pattern associated with a stop of a vehicle as the abnormal event, and an obstacle pattern associated with a road obstacle as the abnormal event.
   5. The traffic monitoring apparatus according to above-described supplementary note 3 or 4, further including
a display control means for causing a display means to display a screen, wherein,
in a case where an abnormal event is detected by the abnormality detection means, the display control means causes to display, on the screen, a road map indicating a place of occurrence of the abnormal event.
   6. The traffic monitoring apparatus according to any one of above-described supplementary notes 3 to 5, further including
an imaging control means for controlling an imaging means for photographing the road, wherein,
in a case where an abnormal event is detected by the abnormality detection means, the imaging control means causes imaging means to photograph a place of occurrence of the abnormal event in an enlarged manner.
   7. The traffic monitoring apparatus according to any one of above-described supplementary notes 1 to 6, further including
a prediction means for generating prediction information indicating a change over time in a vehicle position to be predicted regarding the road, based on first history information generated by the history generation means.
   8. The traffic monitoring apparatus according to above-described supplementary note 7, wherein
the prediction means generates prediction information regarding the road by using, as an input, first history information generated by the history generation means, based on a learned learning model that has performed machine learning in which the prediction information is generated by using, as an input, the first history information for training.
   9. The traffic monitoring apparatus according to any one of above-described supplementary notes 3 to 6, further including,
in a case where an abnormal event is detected by the abnormality detection means, a prediction means for generating prediction information indicating a change over time in a vehicle position to be predicted regarding the road, based on a type of the abnormal event, and first history information generated by the history generation means.
   10. The traffic monitoring apparatus according to above-described supplementary note 9, wherein
the prediction means generates prediction information regarding the road by using, as an input, first history information generated by the history generation means, and a type of an abnormal event detected by the abnormality detection means, based on a learned learning model that has performed machine learning in which the prediction information is generated by using, as an input, the first history information for training, and a type of the abnormal event.
   11. The traffic monitoring apparatus according to above-described supplementary note 9 or 10, further including
an abnormality prediction means for predicting a type of an abnormal event occurring on the road, based on the event-specific history pattern, and a change over time indicated by the prediction information.
   12. The traffic monitoring apparatus according to above-described supplementary note 11, further including
a display control means for causing a display means to display a screen, wherein,
in a case where occurrence of an abnormal event is predicted by the abnormality prediction means, the display control means causes to display, on the screen, a road map indicating a place of occurrence of an abnormal event whose occurrence is predicted.
   13. The traffic monitoring apparatus according to above-described supplementary note 12, further including
a communication means for communicating with a driving control apparatus loaded in the vehicle, wherein,
in a case where occurrence of an abnormal event is predicted by the abnormality prediction means, the communication means transmits, to the driving control apparatus, information indicating a place of occurrence of an abnormal event whose occurrence is predicted.
   14. The traffic monitoring apparatus according to any one of above-described supplementary notes 11 to 13, further including,
in a case where occurrence of an abnormal event is predicted by the abnormality prediction means, a control means for generating, based on a type of an abnormal event whose occurrence is predicted, traffic control information including a traffic control means for alleviating the abnormal event.
   15. The traffic monitoring apparatus according to above-described supplementary note 14, wherein
the control means further generates, based on performance information including the traffic control means adopted to the abnormal event in a past, and an evaluation value indicating a degree of alleviation by the traffic control means, or determination as to whether to be alleviated by the traffic control means, an evaluation value indicating a predicted degree by which an abnormal event whose occurrence is predicted by the abnormality prediction means is alleviated by traffic control means to be generated by the control means, or determination as to whether to be predicted to be alleviated by the traffic control means.
   16. The traffic monitoring apparatus according to above-described supplementary note 14 or 15, wherein
the control means further accepts a traffic control means to be selected by a user from among a traffic control means indicated by the generated traffic control information, and generates decision information indicating the selected traffic control means.
   17. The traffic monitoring apparatus according to above-described supplementary note 16, further including
a display control means for causing a display means to display a screen, wherein
the display control means causes to display, on the screen, decision information to be output from the control means.
   18. The traffic monitoring apparatus according to above-described supplementary note 16 or 17, further including
a communication means for communicating with a driving control apparatus loaded in the vehicle, wherein
the communication means transmits, to the driving control apparatus, decision information to be output from the control means.
   19. The traffic monitoring apparatus according to any one of above-described supplementary notes 14 to 16, wherein
the traffic control means includes at least one of a closure of an interchange, another route for avoiding a point of occurrence of an abnormal event whose occurrence is predicted, a change of a toll of a road, and a dispatch plan of an emergency personnel.
   20. The traffic monitoring apparatus according to any one of above-described supplementary notes 1 to 19, wherein
the history generation means includes
a position change acquisition means for deriving a change over time in the vehicle position, based on the position information,
a traveling direction discrimination means for discriminating whether a traveling direction of the vehicle is a first direction or a second direction opposite to the first direction, based on the derived change over time,
a first generation means for generating the first history information related to the vehicle traveling in the first direction, and
a second generation means for generating second history information indicating a change over time in the vehicle position related to the vehicle traveling in the second direction.
   21. The traffic monitoring apparatus according to any one of above-described supplementary notes 1 to 20, further including
a traffic condition acquisition means for deriving a value of a traffic parameter indicating a traffic condition of the road, based on the first history information, wherein
the traffic parameter includes at least one of a velocity of a vehicle traveling on a road, traffic density of a road, a traffic volume being a volume of a vehicle traveling a predetermined point on a road per unit time, and an occupancy indicating a ratio with which a road is occupied by a vehicle.
   22. A traffic monitoring system including:
the traffic monitoring apparatus according to any one of above-described supplementary notes 1 to 21;
an optical fiber being laid on the road, and including one end to which termination processing of suppressing reflection of an optical signal is applied; and
a sensing apparatus for inputting an optical signal to the optical fiber, and also observing a change amount of light interference intensity being intensity of light with which pieces of back scattered light occurred accompanied by an input of the optical signal interfere with each other, wherein
the position acquisition means acquires the position information on the road to be acquired based on a change amount of the light interference intensity observed by the sensing apparatus.
   23. A traffic monitoring method including,

by a computer:
acquiring position information indicating a vehicle position on a road; and
generating first history information indicating a change over time in the vehicle position, based on the position information.
   24. A program causing a computer to execute:
acquiring position information indicating a vehicle position on a road; and
generating first history information indicating a change over time in the vehicle position, based on the position information.

### REFERENCE SIGNS LIST

100 Traffic monitoring system
101 Vehicle
102 Sensing apparatus
103 Camera
104 Traffic monitoring apparatus
105 Input unit
106 Position acquisition unit
107, 207 History generation unit
108 First learning model storage unit
109 Traffic condition acquisition unit
110 Abnormality detection unit
111 Event-specific history pattern storage unit
112 Prediction unit
113 Second learning model storage unit
114 Abnormality prediction unit
115 Control unit
116 Display unit
117 Display control unit
118 Imaging control unit
119 Communication unit
120 Driving control apparatus
207a Position change acquisition unit
207b Traveling direction discrimination unit
207c First generation unit
207d Second generation unit

What is claimed is:

1. A traffic monitoring apparatus comprising:
position acquisition unit for acquiring position information indicating a vehicle position on a road; and
history generation unit for generating first history information indicating a change over time in the vehicle position, based on the position information.

2. The traffic monitoring apparatus according to claim 1, wherein
the position acquisition unit acquires the position information on the road to be acquired based on optical fiber sensing utilizing an optical fiber being laid on the road.

3. The traffic monitoring apparatus according to claim 1, further comprising
abnormality detection unit for detecting, based on an event-specific history pattern indicating a pattern of a change over time in a vehicle position associated with a type of an abnormal event on a road, and a change over time in the vehicle position indicated by the first history information, the abnormal event on the road.

4. The traffic monitoring apparatus according to claim 3, wherein
the event-specific history pattern includes at least one of a congestion pattern associated with congestion as the abnormal event, a stop pattern associated with a stop of a vehicle as the abnormal event, and an obstacle pattern associated with a road obstacle as the abnormal event.

5. The traffic monitoring apparatus according to claim 3, further comprising
display control unit for causing display moans to display a screen, wherein,
in a case where an abnormal event is detected by the abnormality detection unit the display control unit causes to display, on the screen, a road map indicating a place of occurrence of the abnormal event.

6. The traffic monitoring apparatus according to claim 3, further comprising
imaging control unit for controlling imaging unit for photographing the road, wherein,
in a case where an abnormal event is detected by the abnormality detection unit, the imaging control unit causes imaging unit to photograph a place of occurrence of the abnormal event in an enlarged manner.

7. The traffic monitoring apparatus according to claim 1, further comprising
prediction unit for generating prediction information indicating a change over time in a vehicle position to be predicted regarding the road, based on first history information generated by the history generation unit.

8. The traffic monitoring apparatus according to claim 7, wherein
the prediction unit generates prediction information regarding the road by using, as an input, first history information generated by the history generation unit, based on a learned learning model that has performed machine learning in which the prediction information is generated by using, as an input, the first history information for training.

9. The traffic monitoring apparatus according to claim 3, further comprising,
in a case where an abnormal event is detected by the abnormality detection unit prediction unit for generating prediction information indicating a change over time in a vehicle position to be predicted regarding the road, based on a type of the abnormal event, and first history information generated by the history generation unit.

10. The traffic monitoring apparatus according to claim 9, wherein
the prediction unit generates prediction information regarding the road by using, as an input, first history information generated by the history generation unit, and a type of an abnormal event detected by the abnormality detection unit based on a learned learning model that has performed machine learning in which the prediction information is generated by using, as an input, the first history information for training, and a type of the abnormal event.

11. The traffic monitoring apparatus according to claim 9, further comprising
abnormality prediction unit for predicting a type of an abnormal event occurring on the road, based on the event-specific history pattern, and a change over time indicated by the prediction information.

12. The traffic monitoring apparatus according to claim 11, further comprising
display control unit for causing display to display a screen, wherein,
in a case where occurrence of an abnormal event is predicted by the abnormality prediction unit, the display control unit causes to display, on the screen, a road map indicating a place of occurrence of an abnormal event whose occurrence is predicted.

13. The traffic monitoring apparatus according to claim 12, further comprising
communication unit for communicating with a driving control apparatus loaded in the vehicle, wherein,
in a case where occurrence of an abnormal event is predicted by the abnormality prediction unit the communication unit transmits, to the driving control apparatus, information indicating a place of occurrence of an abnormal event whose occurrence is predicted.

14. The traffic monitoring apparatus according to claim 11, further comprising,
in a case where occurrence of an abnormal event is predicted by the abnormality prediction unit, control unit for generating, based on a type of an abnormal event whose occurrence is predicted, traffic control information including traffic control unit for alleviating the abnormal event.

15. The traffic monitoring apparatus according to claim 14, wherein
the control unit further generates, based on performance information including the traffic control unit adopted to the abnormal event in a past, and an evaluation value indicating a degree of alleviation by the traffic control unit, or determination as to whether to be alleviated by the traffic control unit an evaluation value indicating a predicted degree by which an abnormal event whose occurrence is predicted by the abnormality prediction unit is alleviated by traffic control unit to be generated by the control unit, or determination as to whether to be predicted to be alleviated by the traffic control unit.

16. The traffic monitoring apparatus according to claim 14, wherein
the control unit further accepts traffic control unit to be selected by a user from among traffic control means indicated by the generated traffic control information, and generates decision information indicating the selected traffic control unit.

17. The traffic monitoring apparatus according to claim 16, further comprising
display control unit for causing display to display a screen, wherein
the display control unit causes to display, on the screen, decision information to be output from the control unit.

18. The traffic monitoring apparatus according to claim 16, further comprising
communication unit for communicating with a driving control apparatus loaded in the vehicle, wherein
the communication unit transmits, to the driving control apparatus, decision information to be output from the control unit.

19. The traffic monitoring apparatus according to claim 14, wherein
the traffic control unit includes at least one of a closure of an interchange, another route for avoiding a point of occurrence of an abnormal event whose occurrence is predicted, a change of a toll of a road, and a dispatch plan of an emergency personnel.

20. The traffic monitoring apparatus according to claim 1, wherein
the history generation unit includes
position change acquisition unit for deriving a change over time in the vehicle position, based on the position information,
traveling direction discrimination unit for discriminating whether a traveling direction of the vehicle is a first direction or a second direction opposite to the first direction, based on the derived change over time,
first generation unit for generating the first history information related to the vehicle traveling in the first direction, and
second generation unit for generating second history information indicating a change over time in the vehicle position related to the vehicle traveling in the second direction.

21. The traffic monitoring apparatus according to claim 1, further comprising
traffic condition acquisition unit for deriving a value of a traffic parameter indicating a traffic condition of the road, based on the first history information, wherein
the traffic parameter includes at least one of a velocity of a vehicle traveling on a road, traffic density of a road, a traffic volume being a volume of a vehicle traveling a predetermined point on a road per unit time, and an occupancy indicating a ratio with which a road is occupied by a vehicle.

22. A traffic monitoring system comprising:
the traffic monitoring apparatus according to claim 1;
an optical fiber being laid on the road, and including one end to which termination processing of suppressing reflection of an optical signal is applied; and
a sensing apparatus for inputting an optical signal to the optical fiber, and also observing a change amount of light interference intensity being intensity of light with which pieces of back scattered light occurred accompanied by an input of the optical signal interfere with each other, wherein
the position acquisition unit acquires the position information on the road to be acquired based on a change amount of the light interference intensity observed by the sensing apparatus.

23. A traffic monitoring method comprising,
by a computer:
acquiring position information indicating a vehicle position on a road; and
generating first history information indicating a change over time in the vehicle position, based on the position information.

24. A non-transitory storage medium storing a program causing a computer to execute:
acquiring position information indicating a vehicle position on a road; and
generating first history information indicating a change over time in the vehicle position, based on the position information.
